(19) United States
(12) Patent Application Publication
(10) Pub. No.: US 2012/0008764 A1
(43) Pub. Date: Jan. 12, 2012

(54) METHOD, DISTRIBUTION SYSTEM AND COMPUTER PROGRAM PRODUCT FOR A DETERMINISTIC AUTOMATIC CALL DISTRIBUTION SYSTEM

(75) Inventor: Gerrit Voehringer, Bonn (DE)

(73) Assignee: DEUTSCHE TELEKOM AG, Bonn (DE)

(21) Appl. No.: 13/176,024

(22) Filed: Jul. 5, 2011

Related U.S. Application Data
(60) Provisional application No. 61/361,655, filed on Jul. 6, 2010.

(30) Foreign Application Priority Data
Jul. 6, 2010 (EP) 10 006 939.2

(51) Int. Cl. H04M 3/00

(52) U.S. Cl. 379/266.07

(57) ABSTRACT

A method of routing a communication request of a first party to one of a plurality of second parties uses a distribution system. The method has a first step including transmitting the communication request by the first party to the distribution system. A second step includes transmitting a first party identification information by the first party to the distribution system. A third step includes unambiguous mapping of the first party identification information onto a particular one of the plurality of second parties via the distribution system using a deterministic algorithm that includes a hash algorithm. The deterministic algorithm stochastically distributes a plurality of differing first party identification information among the plurality of second parties. The third step includes calculating a hash value from the first party identification information using the hash algorithm. A fourth step includes routing the communication request to the particular one of the plurality of second parties via the distribution system based on the hash value.

### CROSS REFERENCE TO RELATED APPLICATIONS

This application claims priority to provisional application No. 61/361,655, filed Jul. 6, 2010, and to European Patent Application No. EP 10 006 939.2 filed Jul. 6, 2010, which are hereby incorporated by reference herein in their entirety.

### FIELD

The present invention relates to a method, a distribution system and a computer program product for routing a communication request of a first party to one of a plurality of second parties.

### BACKGROUND

Increasingly, large companies and organizations comprise service centers to interact with their customers via all kinds of telecommunication channels, e.g., to provide product support or to handle information inquiries from customers. Such service centers usually comprise appropriate distribution systems to efficiently handle the large volume of incoming communication requests sent by customers via phone calls, e-mails, SMS, faxes, etc. In the prior art, a large volume of incoming phone calls is handled, e.g., by means of an ACD (Automatic Call Distribution) system comprising a routing strategy to distribute the incoming calls and, thus, the work load among a plurality of call centers and/or call center agents such that the use of call center resources is being optimized. For this purpose, simple ACD systems typically use a random algorithm to route an incoming call randomly to any one of the plurality of available call centers and/or call center agents. In addition, the random algorithm is often based on a predefined rule set which takes into account various parameters like, e.g., the location of the calling customer, time of day, day of the week, etc., to further optimize the use of available call center resources. Such random routing strategies, however, have the drawback that a calling customer will usually be directed to different call centers and/or call center agents each time the calling customer calls the service center. Hence, the calling customer usually has to repeat certain information each time the calling customer calls the service center and, thus, time is wasted both for the calling customer and for the call center agent.

More sophisticated ACD systems, therefore, often comprise a central database, in which important information of each calling customer, e.g., the customer's name, address, phone number and details about inquiries, provided in a previous phone call are recorded. Preferably, each call center and/or call center agent is linked to the central database and can access the recorded information so that an incoming call by a calling customer can be handled very efficiently. Moreover, ACD systems comprising a central database often provide functionality to allocate a particular customer to a particular call center and/or call center agent so that it can be ensured that the particular customer will always be directed to the particular call center and/or call center agent in each subsequent call. Hence, the customer advantageously receives the impression to have a personal contact person being in charge for him. Such ACD systems are, e.g., disclosed in the patent application DE 10 2008 032 360 A1 and in the U.S. Pat. No. 5,703,943 A. However, the disadvantage of such ACD systems is that rather complex communication networks should provide access for each call center and/or call center agent to the central database and, hence, the operation of such central database is comparatively cost-intensive.

### SUMMARY

In an embodiment, the present invention provides a method of routing a communication request of a first party to one of a plurality of second parties using a distribution system. The method has a first step including transmitting the communication request by the first party to the distribution system. A second step includes transmitting a first party identification information by the first party to the distribution system. A third step includes unambiguous mapping of the first party identification information onto a particular one of the plurality of second parties via the distribution system using a deterministic algorithm that includes a hash algorithm. The deterministic algorithm stochastically distributes a plurality of differing first party identification information among the plurality of second parties. The third step includes calculating a hash value from the first party identification information using the hash algorithm. A fourth step includes routing the communication request to the particular one of the plurality of second parties via the distribution system based on the hash value.

These and other characteristics, features and advantages of the present invention will become apparent from the following detailed description, taken in conjunction with the accompanying drawings, which illustrate, by way of example, the principles of the invention. The description is given for sake of example only, without limiting the scope of the invention. The reference figures quoted below refer to the attached drawings.

### BRIEF DESCRIPTION OF THE DRAWINGS

FIG. 1 shows schematically an embodiment of a method according to the present invention for routing a communication request by means of a distribution system.

FIG. 2 shows schematically the routing of two communication requests of a first party and another first party transmitting the same first party identification information.

FIG. 3 shows schematically another embodiment of the method according to the present invention.

FIG. 4 shows schematically the routing of a plurality of communication requests by means of a distribution system according to the embodiment of FIG. 1.

FIG. 5 shows schematically the routing of a plurality of communication requests by means of a distribution system according to another embodiment of the method of the present invention.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g., “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Any person skilled in the art will understand that other modifications or varieties of the invention are possible without departing from the broader spirit of the invention. Such modifications are therefore to be considered as falling within the spirit and the scope of the invention and hence forming part of the invention as herein described or exemplified. Accordingly, the exemplary description is to be regarded in an illustrative sense rather than in a restrictive sense.

In an embodiment, the present invention provides a method, a distribution system and a computer program product for routing a communication request of a first party to one of a plurality of second parties such that the above mentioned drawbacks can be avoided. Therefore, in an embodiment, the present invention provides a method, wherein the method guarantees that a communication request of a particular first party will always be routed to a particular one of the plurality of second parties, wherein the method furthermore realizes that a plurality of communication requests of a plurality of first parties is stochastically distributed among the plurality of second parties, and wherein the method is applicable without the need of an extensive and cost-intensive central database.

In an embodiment, these features are achieved by routing a communication request of a first party to one of a plurality of second parties by means of a distribution system, wherein a first step comprises the transmission of a communication request of the first party to the distribution system, wherein a second step comprises the transmission of a first party identification information by the first party to the distribution system, wherein a third step comprises an unambiguous mapping of the first party identification information onto a particular one of the plurality of second parties by the distribution system using a deterministic algorithm, wherein the deterministic algorithm stochastically distributes a plurality of differing first party identification information among the plurality of second parties, wherein the deterministic algorithm comprises a hash algorithm, wherein the third step comprises the calculation of a hash value from the first party identification information by means of the hash algorithm, wherein a fourth step comprises the routing of the communication request to the particular one of the plurality of second parties by the distribution system in dependence of the hash value.

In the context of the present invention, the term “unambiguous” means that a particular first party identification information will be mapped onto a particular one of the plurality of second parties each time the particular first party identification information is being mapped by the deterministic algorithm.

Furthermore, in the context of the present invention, the term “stochastically” means that distributing any first random set of differing first party identification information among the plurality of second parties according to the deterministic algorithm will result in a first frequency distribution of second parties, wherein distributing any second random set of differing first party identification information according to the deterministic algorithm will result in a second frequency distribution of second parties, wherein the first frequency distribution substantially equals the second frequency distribution, i.e. the frequency of a second party according to the first frequency distribution substantially equals the frequency of the second party according to the second frequency distribution for each of the plurality of second parties. One skilled in the art understands that in order to achieve a good agreement between the first frequency distribution and the second frequency distribution, the number of differing elements of the first and second random set of differing first party identification information being distributed among the plurality of second parties has to be much larger than the number of second parties. In the context of the present invention, “substantially equals” means that if the number of elements of the first and second random set of differing first party identification information is larger than the number of second parties by at least a factor of 1000, the relative deviation between the frequency of a second party according to the first frequency distribution and the frequency of the second party according to the second frequency distribution will be less than 30%, preferably less than 10% and more preferably less than 5% for each of the plurality of second parties. Dependent on the specific embodiment of the deterministic algorithm the first frequency distribution and the second frequency distribution, respectively, correspond to a uniform distribution or a Poisson distribution or a Gaussian distribution or any other non-uniform distribution.

According to an embodiment of the present invention, it is, thereby, advantageously possible that each communication request of a first party will be routed to the same one of the plurality of second parties provided that the same first party identification information is transmitted along with each communication request, wherein a plurality of communication requests is stochastically distributed among a plurality of second parties according to a frequency distribution defined by the deterministic algorithm. According to the present invention, the first party identification information can be any information that identifies the first party, preferably a phone number and/or a fax number and/or an IMSI number and/or an IMEI number and/or an e-mail address and/or an IP address and/or any alphanumerical value. For instance, if a first party sends a communication request to the distribution system via a telephone apparatus connected to the PSTN (Public Switched Telephone Network) the first party identification information could preferably be the phone number of the used telephone apparatus transmitted to the distribution system by Automatic Number Identification (ANI) or Calling Line Identification Presentation (CLIP), wherein according to the method of the present invention the phone number will then be mapped unambiguously onto a particular one of the plurality of second parties by the distribution system. Thus, it can be advantageously ensured that any communication request transmitted via the same telephone apparatus will always be routed to the same one of the plurality of second parties.

The hash algorithm (in the following also called hash function) preferably converts a large, possibly variable-sized amount of data into a small datum, usually a single integer that may serve as an index to an array (associative array). The value returned by the hash function is called the hash value. The hash algorithm can be e.g. a cyclic redundancy check (crc) or a checksum algorithm. The hash algorithm can be non cryptographic (e.g. Pearson hashing) or cryptographic (e.g. BLAKE 256).

According to an embodiment of the present invention it is preferred that in the third step, by performing a modulo n operation on the hash value, a remainder is determined, wherein n is the total number of the second parties, wherein in the fourth step the communication request is routed to the particular one of the plurality of second parties by the distribution system in dependence of the remainder. The modulo operation preferably is an algorithm which finds the remainder of division of one number by another. Given two positive numbers: x (the dividend) and y (the divisor), x modulo y (abbreviated as x mod y) can be thought of as the remainder on division of x by y. Preferably performing the modulo n operation on the hash value means that the hash value is divided by n, which is the total number of the second parties, and the remainder of the division is determined.

According to an embodiment of the present invention, it is, thereby, advantageously possible to assure that a set of differing first party identification information will be stochastically distributed among a plurality of second parties even if the elements of the set of differing first party identification information are very similar to each other, e.g., if the elements of the set of differing first party identification information correspond to numerical values which differ by a few digits only. Furthermore, since the computing time for a hash algorithm is comparatively small, it is advantageously possible to keep hardware requirements and costs for the distribution system low.

According to an embodiment of the present invention, it is preferred that the deterministic algorithm is realized such that distributing a plurality of differing first party identification information among a plurality of second parties according to the deterministic algorithm results in a frequency distribution of second parties, wherein the frequency distribution substantially equals a uniform distribution.

According to an embodiment of the present invention, it is, thereby, advantageously possible that a large volume of communication requests is distributed substantially uniformly among a plurality of second parties. For instance, it is, thereby, advantageously possible that a large volume of incoming calls is evenly distributed by the distribution system among a plurality of call center agents of a service center to provide a well-balanced work load among the call center agents.

According to an embodiment of the present invention, it is, furthermore, preferred that the deterministic algorithm is realized such that distributing a plurality of differing first party identification information among a plurality of second parties according to the deterministic algorithm results in a frequency distribution of second parties, wherein the frequency distribution substantially equals a non-uniform distribution, wherein the deterministic algorithm comprises that a probability factor is assigned to each one of the plurality of second parties, wherein the frequency of each one of the plurality of second parties according to the non-uniform distribution corresponds to the assigned probability factor.

According to an embodiment of the present invention, it is, thereby, advantageously possible that a large volume of communication requests is distributed non-uniformly among a plurality of second parties according to the assigned probability factors. By choosing appropriate probability factors it is, thereby, advantageously possible to flexibly control the fraction of communication requests of the plurality of first parties that will be routed to each one of the plurality of second parties. For instance, it is, thereby, advantageously possible that a large volume of incoming calls is distributed non-uniformly by the distribution system among a plurality of call centers of a service center according to the available capacity of each call center such that the use of call center resources is optimized.

According to an embodiment of the present invention, it is preferred that the first party identification information is transmitted substantially at the same time as the communication request of the first party.

According to an embodiment of the present invention, it is, thereby, advantageously possible to transmit the communication request of the first party and the first party identification information in only one step. For instance, if the communication request is transmitted via a PSTN (Public Switched Telephone Network) the first party identification information could preferably be the phone number of the first party which is transmitted substantially at the same time as the communication request via Automatic Number Identification (ANI) or Calling Line Identification Presentation (CLIP).

According to an embodiment of the present invention, it is preferred that the method according to the present invention comprises a fifth step, wherein the fifth step comprises the transmission of a prompt request by the distribution system to the first party, wherein the fifth step is performed after the first step and prior to the second step.

According to an embodiment of the present invention, it is, thereby, advantageously possible that the first party is requested via the prompt request to manually transmit a particular first party identification information to the distribution system. Thus, it is advantageously possible that a particular first party identification information is transmitted which is not related to the communication channel or terminal being used for the transmission of the communication request. Preferably, the first party can be requested to transmit a customer ID and/or an account number and/or a credit card number and/or a transaction number and/or any alphanumerical value that identifies the first party. For instance, if a communication request of a first party is transmitted to the distribution system via a PSTN, the first party will, e.g., receive a voice message as a prompt request from the distribution system via the PSTN and will be requested by said voice message to key in a customer ID as a first party identification information using the telephone keypad, wherein the customer ID will then be transmitted to the distribution system, e.g., by means of Dual-Tone Multi-Frequency signaling (DTMF) via the PSTN.

According to an embodiment of the present invention, it is, thereby, furthermore advantageously possible that along with each communication request the same first party identification information can be transmitted independent from the terminal and communication channel used for the transmission of the communication request and the first party identification information. For instance, it can, thereby, be advantageously ensured that each communication request of a particular first party will always be routed to the same particular one of the plurality of second parties by the distribution system no matter whether the communication request is transmitted via a phone call or via e-mail or via a SMS or via any other communication channel.

According to an embodiment of the present invention, it is preferred that the communication request is transmitted via a first communication channel, wherein the first party identification information is transmitted via the first communication channel and/or a second communication channel, wherein the prompt request is transmitted via the first communication channel and/or the second communication channel and/or a third communication channel.

According to an embodiment of the present invention, a communication channel preferably comprises a telephone call and/or a video call and/or a SMS (Short Message Service) and/or a MMS (Multimedia Messaging Service) and/or a fax and/or an e-mail and/or an IM (Instant Message) and/or an IP communication. According to the present invention, it is, thereby, advantageously possible that the communication request and the first party identification information and the prompt request are transmitted via the same communication channel, e.g., via a phone call using a PSTN, which makes the communication between the first party and the distribution system comparatively convenient. However, according to the present invention, it is, furthermore, advantageously possible that the communication request and the first party identification request and the prompt request are transmitted via different communication channels, e.g., the communication request and the first party identification information can be transmitted via a phone call using a PSTN and the prompt request can be transmitted via a SMS using a PLMN. One skilled in the art will understand that various other embodiments are possible as well. Using different communication channels advantageously provides a high flexibility for the communication between the first party and the distribution system.

The present invention, furthermore, in another embodiment relates to a distribution system for routing a communication request of a first party to one of a plurality of second parties, wherein the first party transmits a communication request and a first party identification information to the distribution system, wherein the distribution system comprises a reception means for receiving the communication request and for receiving the first party identification information, wherein the distribution system comprises a processor to unambiguously map the first party identification information onto a particular one of a plurality of second parties using a deterministic algorithm, wherein the deterministic algorithm stochastically distributes a plurality of differing first party identification information among the plurality of second parties, wherein the deterministic algorithm comprises a hash algorithm, wherein a hash value from the first party identification information by means of the hash algorithm is calculated, wherein the distribution system comprises a switching means for routing the communication request to the particular one of the plurality of second parties determined by the deterministic algorithm in dependence of the hash value.

According to the present invention, it is preferred that the distribution system furthermore comprises a transmitting means for the transmission of a prompt request.

According to an embodiment of the present invention, it is, thereby, advantageously possible that the first party can be requested by the distribution system to manually transmit a particular first party identification information which is not provided by the communication network itself.

Furthermore, an embodiment of the present invention relates to a program comprising a computer readable program code which, when executed on a computer, causes the computer to perform a method for routing a communication request of a first party to one of a plurality of second parties according to the present invention.

Furthermore, an embodiment of the present invention relates to a computer program product comprising a computer program stored on a storage medium, the computer program comprising a computer readable program code which, when executed on a computer, causes the computer to perform a method for routing a communication request of a first party to one of a plurality of second parties according to the present invention.

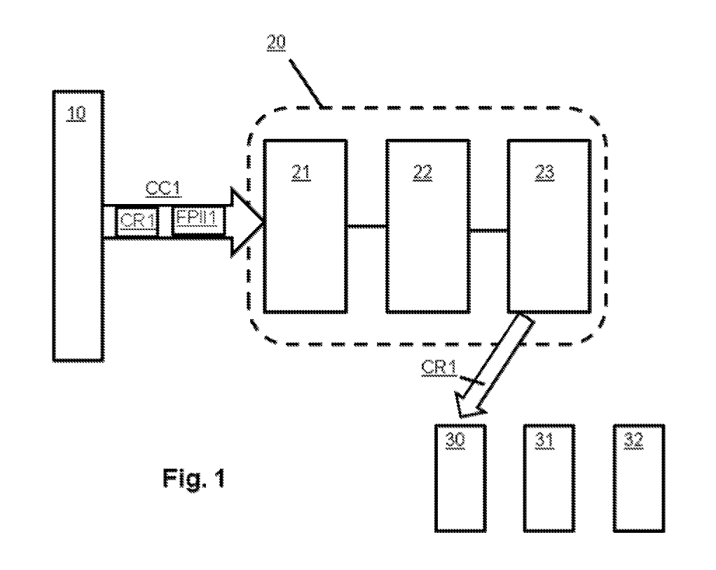

FIG. 1 shows schematically the routing of a communication request CR1 of a first party 10 to a second party 30 of a plurality of second parties 30, 31, 32 by means of a distribution system 20 according to an embodiment of a method of the present invention, wherein the distribution system 20 comprises a reception means 21, a processor 22 and a switching means 23. In a first step of the method, the communication request CR1 is transmitted by the first party 10 to the distribution system 20 via a communication channel CC1, e.g., via a phone call or a fax or a SMS or an e-mail. In a second step, a first party identification information FPII1 is transmitted by the first party 10 to the distribution system 20 via the communication channel CC1. The first party identification information FPII1 can be any alphanumerical value that identifies the first party 10, e.g., a phone number or an e-mail address or a customer ID. Furthermore, it is possible that the first party identification information FPII1 is transmitted to the distribution system 20 using another communication channel (not illustrated) which differs from the communication channel CC1. The communication request CC1 and the first party identification information FPII1 is received by the reception means 21 and passed on to the processor 22. In a third step, the processor 22 executes a computer program product comprising a deterministic algorithm which maps the first party identification information FPII1 unambiguously onto the particular second party 30 of the plurality of second parties 30, 31, 32. One preferred embodiment of a deterministic algorithm according to the present invention is as follows:
first, a list D of n second parties is generated,
second, using a hash function a hash value H is calculated from the first party identification information FPII1, e.g., a MD5 (Message-Digest algorithm 5) hash is calculated: H=MD5(FPII1),
third, a modulo(n) operation is executed on the hash value H resulting in a number i with 0≦i≦n,
fourth, the first party identification information FPII1 is assigned to element i of list D, wherein the element i represents one of the plurality of second parties 30, 31, 32
   For the embodiment depicted in FIG. 1, it follows that D={30, 31, 32}, n=3, i=1 so that the first party identification information FPII1 is mapped onto the particular second party 30 of the plurality of second parties 30, 31, 32.

In a fourth step, the communication request CR1 is passed on to the switching means 23, wherein the switching means 23 routes the communication request CR1 to the particular second party 30 determined by the deterministic algorithm in the third step. The method according to the present invention advantageously ensures that any communication request will be routed to the particular second party 30 by the distribution system 20 provided that along with each communication request the same first party identification information is transmitted. One possible application of the present invention relates to the field of service centers, wherein an incoming call of a calling customer originating from a telephone apparatus is routed to one of a plurality of call centers and/or call center agents, wherein it is possible to assure that any subsequent call of the calling customer originating from the same telephone apparatus, will be routed to the same one of the plurality of call centers and/or call center agents, i.e., a particular calling customer is coupled to a particular call center and/or call center agent. However, this is only an example used for the sake of illustration. The method, the distribution system 20 and the computer program product according to embodiments of the present invention is not restricted to phone calls but can be applied for any communication channel being used for a communication between the first party 10 and the distribution system 20 like, e.g., SMS communication, fax communication, e-mail communication or IP communication. Furthermore, the communication request CR1 and/or the first party identification information FPII1 can be transmitted via any terminal, e.g., a telephone apparatus connected to the PSTN, a mobile phone connected to the PLMN or a computer terminal connected to an IP network.

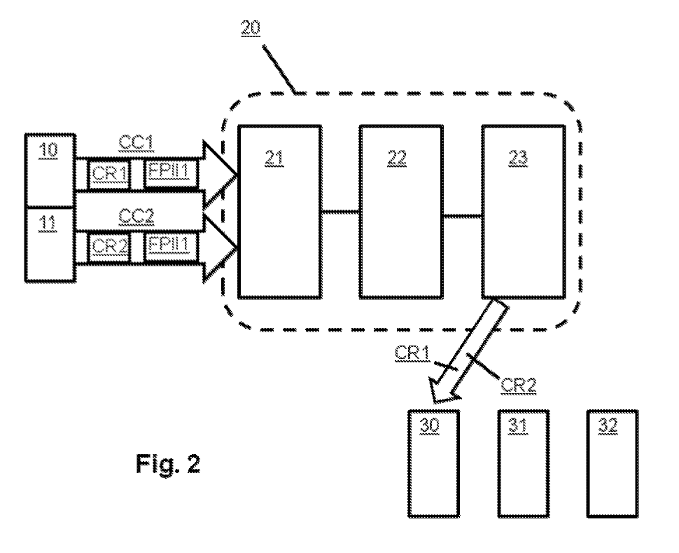

FIG. 2 shows schematically the routing of two communication requests CR1, CR2 to a plurality of second parties 30, 31, 32. In the first and second step according to an embodiment of the present invention, a first party 10 transmits a communication request CR1 and a first party identification information FPII1 to the distribution system 20 using a communication channel CC1, wherein another first party 11 transmits another communication request CR2 and the first party identification information FPII1 using another communication channel CC2. For instance, the first party 10 uses a telephone apparatus connected to the PSTN to transmit the communication request CR1 and a customer ID (as the first party identification information FPII1) via a phone call, wherein the other first party 11 uses a mobile phone connected to the PLMN and transmits the other communication request CR2 and the same customer ID via a mobile phone call. In the third step according to the present invention, the first party identification information FPII1 transmitted by the first party 10 and the first party identification information FPII1 transmitted by the other first party 11 are both mapped onto the same second party 30 of the plurality of second parties 30, 31, 32 by the distribution system 20 according to the deterministic algorithm described for FIG. 1 since the deterministic algorithm according to the present invention ensures an unambiguous mapping of the first party identification information FPII1. According to the present invention, it is, thereby, advantageously possible to assure that any communication request transmitted to the distribution system 20 will be routed to the same second party 30 independent from the terminal or communication channel being used by a first party provided that along with each communication request the same first party identification information FPII1 is transmitted.

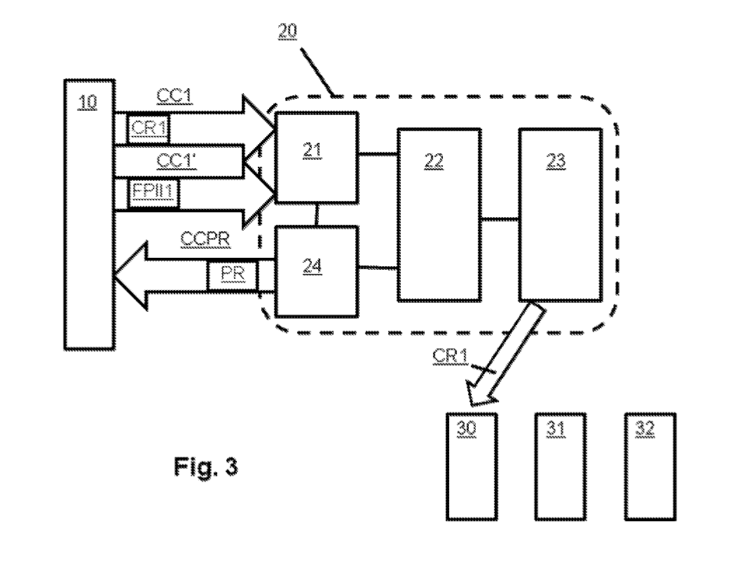

FIG. 3 shows schematically another embodiment of a method according to the present invention, wherein the method is similar to the method described for FIG. 1, but wherein the method comprises a fifth step, wherein the fifth step is performed after the first step, i.e., after the transmission of the communication request CR1 of the first party 10 using the communication channel CC1, and wherein the distribution system 20 comprises a transmitting means 24 for a transmission of a prompt request PR using a prompt request communication channel CCPR. In the fifth step, the communication request CR1 is received by the reception means 21, wherein the reception means 21 triggers the transmitting means 24 to send the prompt request PR to the first party 10 using the prompt request communication channel CCPR. For instance, the first party 10 is requested by the prompt request PR to transmit a particular first party identification information FPII1. Thereby, it is advantageously possible that, e.g., the distribution system 20 requests a particular first party identification information FPII1 that is not provided by the communication network itself and, thus, can only be provided manually by the first party 10, e.g., a customer ID. In the third step, according to the present invention, the first party 10 then transmits the requested first party identification information FPII1 using a further communication channel CC1′. In the third step, the first party identification channel FPII1 is received by the reception means 21 and is mapped unambiguously according to the deterministic algorithm described for FIG. 1 onto a particular second party 30 of the plurality of second parties 30, 31, 32 by the distribution system 20, wherein in the fourth step the communication request CR1 is routed to the particular second party 30 of the plurality of second parties 30, 31, 32.

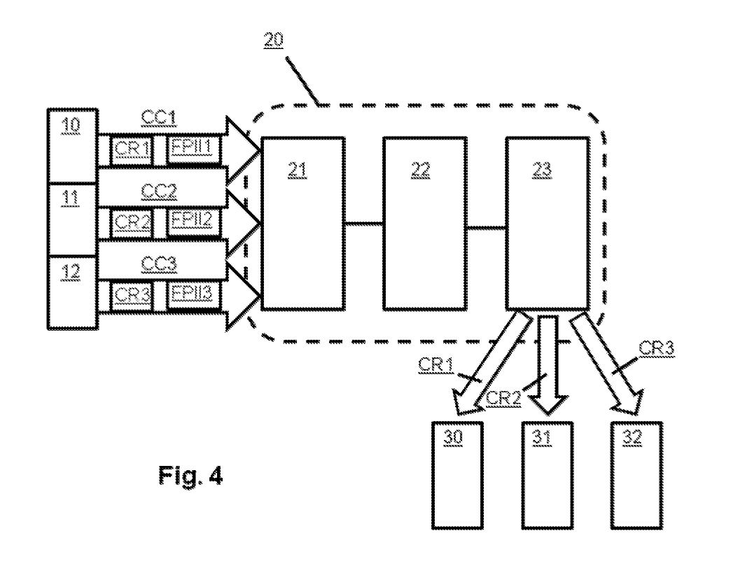

FIG. 4 shows schematically the routing of a plurality of communication requests CR1, CR2, CR3 of a plurality of first parties 10, 11, 12 to a plurality of second parties 30, 31, 32 by means of the distribution system 20. In the first step and in the second step of the method according to the present invention, a first party 10 transmits a communication request CR1 and a first party identification information FPII1 to the distribution system 20 using a communication channel CC1, wherein another first party 11 transmits another communication request CR2 and another first party identification information FPII2 to the distribution system 20 using another communication channel CC2 and wherein the third first party 12 transmits a third communication request CR3 and a third first party identification information FPII3 to the distribution system 20 using a third communication channel CC3. For instance, the communication channel CC1 corresponds to a phone call, the other communication channel CC2 corresponds to a SMS communication and the third communication channel CC3 corresponds to an e-mail communication. However, according to an embodiment of the present invention, it is also possible that each first party of the plurality of first parties 10, 11, 12 uses the same communication channel. In the third step, each first party identification information of the plurality of first party identification information FPII1, FPII2, FPII3 is mapped unambiguously onto one of the plurality of second parties 30, 31, 32 using the deterministic algorithm described for FIG. 1. The particular embodiment of the deterministic algorithm described for FIG. 1 ensures that the plurality of first party identification information 10, 11, 12 is distributed substantially evenly among the plurality of second parties 30, 31, 32. Thus, as illustrated in FIG. 2, e.g., the first party identification information FPII1 is mapped onto a particular second party 30, the other first party identification information FPII2 is mapped onto another particular second party 31 and the third first party identification information is mapped onto a third particular second party 32. Accordingly, the distribution system 20 will route the communication request CR1 to the particular second party 30, the other communication request CR2 to the other particular second party 31, and the third communication request CR3 to the third particular second party 32. However, this is only one example used for the sake of illustration and one skilled in the art will understand that any other uniform distribution of the communication requests CR1, CR2, CR3 among the plurality of second parties 30, 31, 32 is possible.

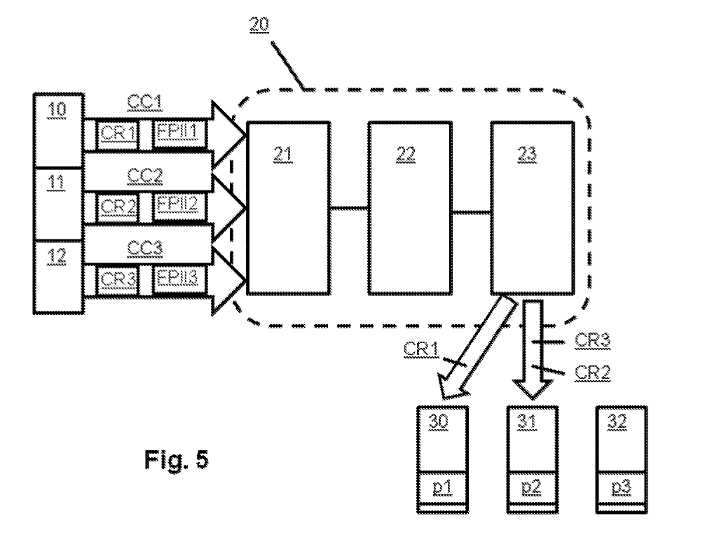

FIG. 5 shows schematically another embodiment of a method according to the present invention, wherein this embodiment is similar to the embodiment described in FIG. 4, but wherein the third step comprises a second deterministic algorithm to map a plurality of first party identification information FPII1, FPII2, FPII3 unambiguously onto a plurality of second parties 30, 31, 32. According to this embodiment of, the plurality of first party identification information FPII1, FPII2, FPII3 is distributed non-uniformly among the plurality of second parties 30, 31, 32 according to probability factors p1, p2, p3 assigned within the second deterministic algorithm to each second party of the plurality of second parties 30, 31, 32, wherein a first probability factor p1 is assigned to a particular second party 30, wherein a second probability factor p2 is assigned to another particular second party 31, wherein a third probability factor p3 is assigned to a third particular second party 32. The probability factors p1, p2, p3 can be any numerical values between 0 and 1, wherein the sum over all probability factors p1, p2, p3 equals 1. According to the third embodiment depicted in FIG. 5, e.g., p1 equals ⅓, p2 equals ⅔ and p3 equals 0. Thus, one first party identification information FPII1 of the plurality of the first party identification information FPII1, FPII2, FPII3 is mapped onto the particular second party 30, two first party identification information FPII2, FPII3 of the plurality of the first party identification information FPII1, FPII2, FPII3 are mapped onto the other particular second party 31 and none of the plurality of the first party identification information FPII1, FPII2, FPII3 is mapped onto the third particular second party 32 by the distribution system 20 using the second deterministic algorithm. Accordingly, the communication request CR1 is routed to the particular second party 30 and the communication request CR2 and the communication request CR3 are routed to the other particular second party 31 by the distribution system 20. According to the third embodiment of the inventive method, it is, thus, advantageously possible to control the fraction of the plurality of communication requests 10, 11, 12 routed to each second party of the plurality of second parties 30, 31, 32 by choosing appropriate probability factors p1, p2, p3 within the second deterministic algorithm. One possible application of the present invention according to the third embodiment relates to a service center, wherein the fraction of incoming calls routed to each call center and/or call center agent of a plurality of call centers and/or call center agents can be controlled by means of the probability factors p1, p2, p3. Hence, it is, e.g., advantageously possible to balance the work load among a plurality of call centers with regard to the capacity of each call center. One preferred embodiment of the second deterministic algorithm is as follows:
first, a list D of k entries is generated, whereas D contains each second party of the plurality of second parties 30, 31, 32 with a frequency according to the probability factors p1, p2, p3 assigned to each second party of the plurality of second parties 30, 31, 32
second, using a hash function, a hash value H is calculated for each of the plurality of first party identification information FPII1, FPII2, FPII3
third, a modulo(k) operation is executed on each hash value H resulting in a number i with 0≦i≦k,
fourth, each of the plurality of first party identification information FPII1, FPII2, FPII3 is assigned to an element i of list D, wherein each element i represents a second party of the plurality of second parties 30, 31, 32.
   For the embodiment depicted in FIG. 5, the list D contains the particular second party 30 with a frequency of one, wherein the list D contains the other particular second party 31 with a frequency of two, wherein the list D contains the third particular second party 32 with a frequency of zero such that D={30, 31, 31} and k=3.

1-10. (canceled)

11. A method of routing a communication request of a first party to one of a plurality of second parties using a distribution system, the method comprising:
a first step including transmitting the communication request by the first party to the distribution system;
a second step including transmitting a first party identification information by the first party to the distribution system;
a third step including unambiguous mapping of the first party identification information onto a particular one of the plurality of second parties via the distribution system using a deterministic algorithm including a hash algorithm, the deterministic algorithm stochastically distributing a plurality of differing first party identification information among the plurality of second parties, the third step including calculating a hash value from the first party identification information using the hash algorithm; and
a fourth step including routing the communication request to the particular one of the plurality of second parties via the distribution system based on the hash value.

12. The method recited in claim 11, wherein the third step includes determining a remainder by performing a modulo n operation on the hash value, wherein n is a total number of the second parties, and
wherein the fourth step includes routing the communication request to the particular one of the plurality of second parties via the distribution system based on the remainder.

13. The method recited in claim 11, wherein the deterministic algorithm is configured to distribute a plurality of differing first party identification information among a plurality of second parties so as to result in a frequency distribution of second parties, the frequency distribution substantially equaling a uniform distribution.

14. The method recited in claim 11, wherein the deterministic algorithm is configured to distribute a plurality of differing first party identification information among a plurality of second parties so as to result in a frequency distribution of second parties, the frequency distribution substantially equaling at least one of a Poisson distribution and a Gaussian distribution,
wherein the deterministic algorithm includes a probability factor assigned to each one of the plurality of second parties, and
wherein a frequency of each of the plurality of second parties according to the frequency distribution corresponds to the respective assigned probability factor.

15. The method recited in claim 11, further comprising a fifth step including transmitting a prompt request via the distribution system to the first party, the fifth step being performed after the first step and prior to the second step.

16. The method recited in claim 11, wherein the transmitting the communication request uses a first communication channel, and wherein the transmitting the first party identification information uses at least one of the first communication channel and a second communication channel.

17. The method recited in claim 15, wherein the transmitting the communication request uses a first communication channel, wherein the transmitting the first party identification information uses at least one of the first communication channel and a second communication channel, and wherein the transmitting the prompt request uses at least one of the first communication channel, the second communication channel and a third communication channel.

18. A distribution system for routing a communication request of a first party to one of a plurality of second parties, the first party transmitting the communication request and a first party identification information to the distribution system, the distribution system comprising:
a reception device configured to receive the communication request and the first party identification information;
a processor configured to unambiguously map the first party identification information onto a particular one of the plurality of second parties using a deterministic algorithm, the deterministic algorithm being configured to stochastically distribute a plurality of differing first party identification information among the plurality of second parties, the deterministic algorithm including a hash algorithm configured to calculate a hash value from the first party identification information; and
a switching device configured to route the communication request to the particular one of the second parties based on the hash value.

19. The distribution system recited in claim 18, further comprising a transmitting device configured to transmit a prompt request.

20. A computer program product comprising a storage medium having computer readable program code stored thereon, the computer readable program code including instructions executable by a computer for carrying out a method for routing a communication request of a first party to one of a plurality of second parties, the method comprising:
a first step including transmitting the communication request by the first party to the distribution system;
a second step including transmitting a first party identification information by the first party to the distribution system;
a third step including unambiguous mapping of the first party identification information onto a particular one of the plurality of second parties via the distribution system using a deterministic algorithm including a hash algorithm, the deterministic algorithm stochastically distributing a plurality of differing first party identification information among the plurality of second parties, the third step including calculating a hash value from the first party identification information using the hash algorithm; and
a fourth step including routing the communication request to the particular one of the plurality of second parties via the distribution system based on the hash value.
